(19) United States
(12) Patent Application Publication
(10) Pub. No.: US 2015/0381110 A1
(43) Pub. Date: Dec. 31, 2015

(54) RECEIVER FOR SOLAR PLANTS AND SOLAR PLANT

(71) Applicant: SUNOYSTER SYSTEMS GMBH, Halstenbek (DE)

(72) Inventors: Carsten CORINO, Halstenbek (DE); Thies WERNICKE, Berlin (DE)

(73) Assignee: SunOyster Systems GmbH, Halstenbek (DE)

(21) Appl. No.: 14/766,398

(22) PCT Filed: Feb. 6, 2014
(86) PCT No.: PCT/EP2014/052359

§ 371 Date: Aug. 6, 2015

(30) Foreign Application Priority Data
Feb. 6, 2013 (DE) 10 2013 201 938.6

(51) Int. Cl. H02S 40/44; F03G 6/06; F24J 2/38; F24J 2/05

(52) U.S. Cl. CPC H02S 40/44; F24J 2/05; F03G 6/065; F03G 6/068; F24J 2/38; F03G 2006/061

(57) ABSTRACT

The invention relates to a receiver for mounting in the focal line of a solar collector having a linear focusing mirror element. The receiver has an elongate hollow profile with a duct for heat transfer fluid, and solar cells on one side of the hollow profile for converting solar radiation into electrical energy. The solar cells and the hollow profile are heat-conductively connected and mounted in a transparent protective tube. Between the protective tube and the solar cells is at least one beam-manipulating element, and the hollow profile, solar cells, protective tube and beam-manipulating element of the receiver are positioned in fixed relation to each other. The invention also relates to a solar plant having a linear focusing optical element with a receiver mounted in its focal line, and the receiver is designed and arranged so that the solar cells of the receiver are facing the linear focusing optical element.

### REFERENCE TO RELATED APPLICATIONS

This application is a national stage application under 35 USC 371 of International Application No. PCT/EP2014/052359, filed Feb. 6, 2014, which claims priority to German Application No. 10 2013 201 938.6, filed Feb. 6, 2013, there entire contents of which are incorporated herein by reference.

### FIELD OF THE INVENTION

The invention relates to a receiver for arrangement in the focal line of a solar collector having a linearly focusing mirror element, and to a solar plant having a corresponding receiver.

### BACKGROUND OF THE INVENTION

Solar collectors, in which the incident solar radiation is focused on to a line by optical elements, are known in the art. Typical examples of corresponding optical elements are parabolic troughs. Arranged along the focal line of a corresponding solar collector there is a receiver, which converts the solar radiation, concentrated by the optical element, into useful energy.

There are known in the art, as receivers, on the one hand, a thermal receiver, in which the linearly concentrated solar radiation is incident upon an absorber tube, flowing through which there is a heat transfer fluid. The heat transfer fluid is thereby heated, and the thus obtained thermal energy can then be used. In order to increase the efficiency of a corresponding receiver, it is known to design the absorber tube as a double-walled tube. In this case, the inner tube wall is configured in such a manner that it has a high absorptive capacity for solar radiation, while the outer tube wall has a high transmittance for solar radiation. The space between the tube walls is vacuumed. The inner tube wall, through which the heat transfer fluid flows, is thereby thermally insulated from the environment.

Furthermore, there are also known in the art dual receivers, in which the linearly concentrated solar radiation is incident upon photovoltaic cells, by means of which the solar radiation is converted, at least partially, into electrical energy. A cooling tube, flowing through which there is a heat transfer fluid, is arranged on the back side of the photovoltaic cells, in order to keep the temperature of the photovoltaic cells within an acceptable range. The heating of the heat transfer fluid that then occurs can be used as thermal energy.

### SUMMARY OF THE INVENTION

The invention is based on an object of creating both an improved receiver for arrangement in the focal line of a solar collector having a linearly focusing mirror element, and an improved solar plant.

This can be achieved by a receiver according to the main claim, and by a solar plant according to the coordinate claim. Advantageous developments are disclosed in the detailed embodiments described below.

Accordingly, the invention relates to a receiver for arrangement in the focal line of a solar collector having a linearly focusing mirror element, which has an elongate hollow profile having a duct for heat transfer fluid and having solar cells, arranged on one side of the hollow profile, for converting solar radiation into electrical energy, wherein the solar cells and the hollow profile are connected in a thermally conductive manner, and the hollow profile, having the solar cells arranged thereon, is arranged in a transparent casing tube in such a manner that at least one beam-manipulating element is arranged between the casing tube and the solar cells, wherein the hollow profile, solar cells, the casing tube and beam-manipulating element of the receiver are in a fixed position in relation to each other.

The invention additionally relates to a solar plant, having a linearly focusing mirror element, arranged in the focal line of which there is a receiver, wherein the receiver is designed according to the invention and is arranged in such a manner that the solar cells face toward the linearly focusing mirror element.

A “beam-manipulating element” is understood to mean an optical element that refracts, reflects or diffracts a light beam.

In the case of the receiver according to the invention, the solar radiation is converted both into electrical energy and into thermal energy. The invention has identified that, in the case of correspondingly combined receivers, having hollow profiles, through which there flows a heat transfer fluid and having solar cells arranged thereon, arrangement in a transparent casing tube is particularly advantageous in its effect when the beam-manipulating element, the casing tube and the hollow profile, as well as the solar cell, are in a fixed position in relation to each other. In this case, contrary to the preconception of the experts, according to which solar radiation is to be incident upon solar cells with as little disturbance as possible, in order to achieve the greatest possible efficiency, an element that is not required for concentrating the solar radiation on to the solar cells—namely, the wall of the casing tube—is introduced into the beam path between the sun and the solar cells. The associated reduction in efficiency in the generation of electrical energy by the solar cells is more than compensated by the reduction in the heat losses, and consequently the increase in efficiency in the extraction of thermal energy, and by the effect of the beam-manipulating element arranged there. Moreover, the casing tube offers the advantage that the solar cells and beam-manipulating element inside it are protected against detrimental environmental influences, for example caused by water, and cleaning of the receiver, when soiled, is made easier.

These advantages are brought together by the combination with a simple structure of the receiver, in which it is possible to dispense with moving elements entirely. It is thus possible to avoid servicing of the receiver, which would require, for example, complete or partial disassembly, opening of the casing tube, or the provision of service flaps, or similar. A corresponding receiver having beam-manipulating elements is then particularly suited for solar plants having two-axis tracking, i.e. in respect of the elevation and the azimuth.

Preferably, the beam-manipulating elements between the casing tube and the hollow profile are realized as optical concentrator elements, by means of which incident solar rays that are focused linearly on to the receiver are concentrated into individual focal points along the focal line. The solar cells are then arranged in the focal points. A corresponding second focusing of the solar radiation, from a focal line to individual focal points, causes the radiation intensity to be increased at these points in such a manner that concentrator photovoltaic cells can be used as solar cells, in order to convert the solar radiation into electrical energy. Linear Fresnel lenses, oriented perpendicularly in relation to the extent of the hollow profile, may be provided as optical concentrator elements. Preferably, the individual solar cells are each individually protected by a bypass diode.

It may also be provided, however, that the beam-manipulating element is realized as a beam splitter, which splits incident solar radiation according to the wavelength, and deflects it on to the solar cell optimized for the respective wavelength. Various types of solar cell may thus be provided. The beam splitter may be designed, in particular, as a beam-splitter cube, as a beam-splitter plate or as a (transmission) grating. A corresponding splitting of the incident solar radiation makes it possible to use less expensive solar cells.

It is to be noted that the aforementioned beam concentration, on the one hand, and the beam splitting, on the other hand, may also be provided in combination.

The region between the hollow profile and the casing tube may be vacuumed. Good thermal insulation of the hollow profile is thereby achieved. It is preferred, in particular in connection with a vacuum in the region between the hollow profile and the casing tube, but also in the case of other embodiments, if the hollow profile and/or the casing tube are made of glass. A vacuum in the region between the hollow profile and the casing tube can thus be permanently maintained. Moreover, glass is resistant to corrosion by many substances, and in particular many heat transfer fluids. The elements arranged in the region between the hollow profile and the casing tube, such as, for example, the solar cells, are preferably stable against outgassing. It may also be provided that the region between the hollow profile and the casing tube is filled with inert gas.

In order to hermetically seal the casing tube against contamination, it may be provided that gas connections are provided at both ends of the casing tube. This enables the region between the hollow profile and the casing tube to be flushed in a simple and effective manner, in particular with inert gas.

At least one reflector may be provided, between the hollow profile and the casing tube, on the side of the hollow profile that faces away from the solar cells. The reflector is designed to reflect the thermal radiation that comes from the hollow profile back on to the latter, enabling the heat loss to be further reduced. It is additionally designed to reflect light radiation that comes from the beam-manipulating elements and that has missed the hollow profile—in particular due to misfocusing—back on to the hollow profile. This at least one reflector may be applied (e.g. vapor-deposited) directly on to the casing tube, or may be composed of a metal foil (for example, aluminum foil), which is preferably of a multilayer design and has heat-resistant separating layers between the individual foils.

The beam-manipulating element may be integral with the casing tube. For example, the beam-manipulating elements may be milled into the casing tube. They may also be pressed into the casing tube. The number of individual components for the receiver according to the invention can thus be reduced. It may also be provided to permanently connect the beam-manipulating elements to the casing tube, for example in that they are adhesive-bonded directly on to the casing tube, or modeled on to the latter by means of silicone. Such a combination facilitates assembly in the field and, in addition, precise positioning between the beam-manipulating element and the casing tube is easy to achieve.

The hollow profile is preferably semi-cylindrical or horseshoe-shaped. Horseshoe-shaped is understood to mean a shape that is similar in form to a half-cylinder, wherein, however, the secant line does not go through the mid-point, as in the case of the half-cylinder, but higher or lower. This, with the secant line, offers a flat front side for receiving the solar cells, while the back side, being approximately half-round in form, is shaped so as to be congruent with the inner wall of the casing tube, and thus provides for secure and stable seating there. A cross section of optimum magnitude for the heat transfer fluid flowing in the hollow profile is thereby achieved. It is particularly expedient in this case if the flat front side is smoothed, for example by face-milling. This results in a large-area support for the solar cells on the hollow profile, thereby improving the heat transfer, and consequently the efficiency.

Milled recesses or strip-type protuberances, for example, may advantageously be provided on the front side of the hollow profile, in order thus to form large-area receiving pockets for the solar cells, in particular panels composed of a plurality of solar cells.

The hollow profile is expediently fixed to at least one holding disks (in the case of a plurality of holding disks spaced apart from each other) in the casing tube. The holding disks are matched, in their outer contour, to the inner wall of the casing tube, and thus enable the hollow profile to be securely positioned in the casing tube without play. Advantageously, the holding disks are realized in two parts, such that, to facilitate assembly, they can be easily fitted on to the hollow profile and then connected to each other. It has proved effective to provide the holding disks, in their upper region that faces toward the mirror element, with a cut-out that extends as far as the solar cell. A shading-free beam path to the solar cell is then ensured, even when the azimuth orientation of the mirror, or receiver, is not optimal, and the light is therefore incident in a laterally oblique manner.

In order to improve the behavior in the case of heating, the hollow profile is preferably set, in respect of its thermal longitudinal extent, such that it is approximately equal in amount to that of the casing tube. This may be achieved, in particular, by the choice of material from which the hollow profile is made. Such an alloy is used that, at the expected operating temperatures, the hollow profile extends, as a result of thermal longitudinal deformation, just as much as the casing tube. Strain is thereby reduced to a minimum, this being of considerable advantage for the tightness of seal and, particularly in the case of vacuumed casing tubes, improving the operational reliability considerably. Advantageously, the hollow profile is composed of graphite, at least partially.

In order to ensure an effective transfer of heat between the solar cells and the hollow profile, preferably at least one tensioning element is to be provided, which grips around the hollow profile and at least one solar cell in such a manner that the at least one solar cell is pressed on to the hollow profile. It is particularly expedient to realize the tensioning element as a clamping element. The clamping element may be made, for example, of spring steel. Preferably, the tensioning element has a plurality of fingers, this being in the region thereof that acts upon the solar cell. This enables the solar cells to be securely coupled to the hollow profile in a manner that is favorable for thermal conduction, even in the case of unfavorable circumstances, for example even if the locating surface on the hollow profile for receiving the solar cell is not completely smooth.

In the case of a particularly preferred embodiment, the solar cell is spanned on its front side (i.e. the side facing away from the hollow profile) by a transparent pressure plate. Moreover, the pressure plate is rigid. As a result, in the case of holding by the tensioning element, the solar cell is pressed more evenly on to the hollow profile, over virtually its entire surface.

The thermal transfer is thus further improved, even when the locating surface on the hollow profile is not completely smooth.

It has proved effective to provide a widened portion, which acts as a locating surface for the tensioning element, at at least one lateral edge (edge extending along the focal line) on the outside of a substrate carrying the solar cell. The width of the widened portion is selected such that, irrespective of the light conditions, the tensioning element does not cast any shade at all on to the active surface of the solar cell. By means of the widened portion, it is thus possible, on the one hand, to achieve a mounting that is mechanically very secure, but also, on the other hand, one that is free of shading, and therefore favorable in respect of efficiency.

It is further preferred to provide at least one mirror plate that is configured as a light trap for at least one solar cell. The “configuration as a light trap” in this context means that the mirror plate is arranged such that the solar radiation that is incident upon the mirror plate, substantially perpendicularly in relation to the surface of the at least one solar cell, is deflected on to the at least one solar cell.

Furthermore, fins may be provided in the duct for the heat transfer fluid of the hollow profile, in regions in which solar cells are arranged on the hollow profile. These fins are preferably streamlined in form, such that the flow resistance for the heat transfer fluid in the hollow profile is increased as little as possible. By means of corresponding fins, the transfer of heat between the hollow profile and the heat transfer medium is increased precisely at the points at which heat is put into the hollow profile by the solar cells. It is particularly preferred if the fins are arranged in a discontinuous manner, this being in the direction of flow of the heat transfer fluid, i.e. along the hollow profile. Expedient embodiments are in the form of barbs, or in the manner of a comb. Swirling of the flow in the heat transfer fluid is thereby achieved, resulting in a better transfer of heat between the fins and the heat transfer fluid. In this way, there is better cooling of the solar cells arranged above the fins.

The solar cells may be concentrator photovoltaic cells and/or thermovoltaic cells. The solar cells are preferably electrically insulated in respect of the hollow profile and, if necessary, other components with which the solar cells are in contact. Individual solar cells may be connected to form module strips. Bypass diodes may be provided for individual solar cells or a plurality of solar cells, or for individual module strips or a plurality of module strips. The solar cells of the receiver may preferably be connected in series. This offers the advantage that the voltage generated by a receiver is increased, thereby enabling line losses to be reduced.

Preferably, two or more of the solar cells, which are arranged transversely in relation to the longitudinal extent of the receiver, are connected in parallel in pairs, and the thus formed pairs, in turn, are connected in series. The pairs each comprise two or more solar cells. This combined interconnection makes it possible to form efficient solar-cell panels, even with solar cells that are relatively small and that, owing to the bimetal effect, are less susceptible to breaking down. In the case of the parallel connection in pairs, the solar cells that are connected in parallel behave electrically, to a large extent, like a single, multiply sized solar cell. This parallel connection offers that advantage that an occurring weaker irradiation of one of the parallel-connected solar cells of the pair does not result in disadvantages, known per se, in the case of shading of series-connected solar cells (voltage reversal, reverse currents, hot spots). The parallel connection in pairs thus increases the robustness. By means of the series connection that is then effected, high voltages are achieved, such that the amperage to be transmitted in the case of high outputs can be minimized.

A bypass diode is assigned, expediently, to the solar cells connected in parallel in pairs. It serves to bypass any failed solar cells, and thereby to keep the higher-order series connection of the solar cells capable of continued functioning. It is particularly preferred if the bypass diode is arranged on a common substrate with the two solar cells connected in parallel in pairs. Preferably, the bypass diode is realized without a housing, wherein it is further preferably protected by a reflector that is mounted between the bypass diode and the casing tube, and that is not connected to the bypass diode. The bypass diode is then coupled to the heat transfer fluid in a thermally optimum manner. This offers the advantage that the bypass diode, which occasionally is subjected to very high thermal loading, is cooled effectively in this manner, since it obtains access to the cooling surfaces of the actual solar cells (see above, additional cooling by arrangement of fins). Owing to this arrangement, there is thus no longer a risk of overheating, and therefore of failure of the bypass diode (which could consequently result in a failure of the entire panel).

The receiver according to the invention is preferably used in a solar plant that comprises a linearly focusing mirror element, in the focal line of which a receiver according to the invention is arranged in such a manner that the solar cells of the receiver face toward the mirror element. A corresponding solar plant is provided by the coordinate claim. For explanation of the solar plant, reference is made to the statements above.

It is preferred if the solar plant comprises a Stirling engine, an Organic Rankine Cycle (ORC) system or a thermal refrigerating machine that is operated with heat transfer fluid heated in the receiver.

The solar plant can preferably track on one axis (in respect of the elevation) or two axes (in respect of the elevation and azimuth) of the sun. It can thereby be ensured that, throughout the course of the day, the receiver is located in the focal line of the linearly focusing mirror element and—in the case of optical concentrator elements in the receiver—that the solar cells are located in the individual focal points.

Insofar as a solar plant has two or more receivers, these may preferably be linked—for example, by means of a Tichelmann connection—in parallel. This makes it possible to achieve a more even temperature of the heat transfer fluid, even in the case of short-term and/or partial shading, such as, for example, caused by clouds.

The heat transfer fluid may preferably be a calcium chloride solution.

### BRIEF DESCRIPTION OF THE DRAWINGS

The invention is now described exemplarily on the basis of exemplary embodiments and with reference to the appended drawings. There are shown in:

FIG. 1 an exemplary embodiment of a solar plant according to the invention;

FIG. 2 a first exemplary embodiment of a receiver according to the invention;

FIG. 3 a second exemplary embodiment of a receiver according to the invention;

FIG. 4 a third exemplary embodiment of a receiver according to the invention;

FIG. 5 a fourth exemplary embodiment of a receiver according to the invention;

FIG. 6 a fifth exemplary embodiment of a receiver according to the invention;

FIG. 7a-c detail representations relating to fins in the hollow profile;

FIGS. 8a-b side view and top view of a solar cell having parallel and series-type interconnection; and

FIG. 9 a detail representation relating to the fixed arrangement of hollow profile, cell and beam-manipulating element.

### DETAILED DESCRIPTION OF THE INVENTION

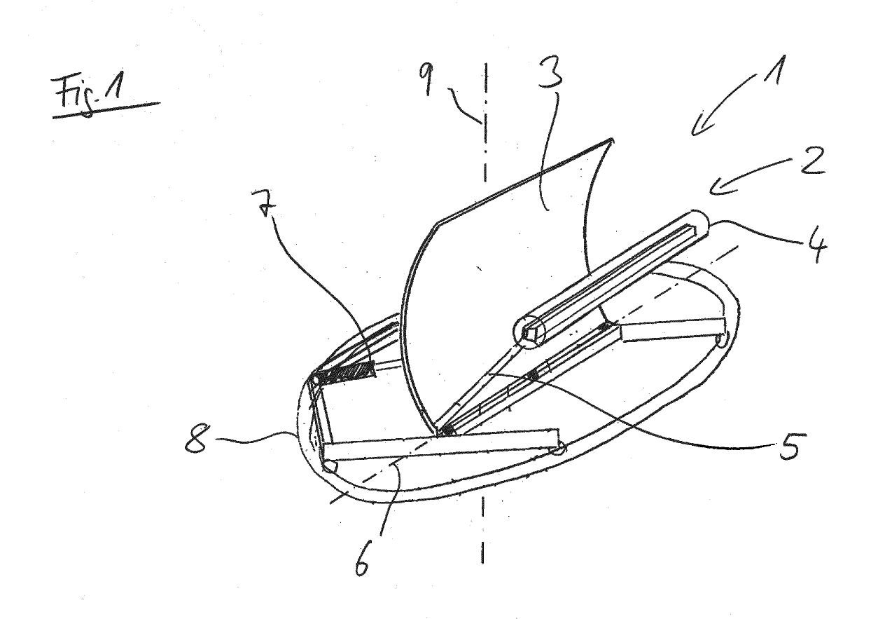

A solar plant 1 according to the invention is represented in FIG. 1. The solar plant 1 comprises a collector unit 2, having a linearly focusing mirror element 3 and an elongate receiver 4. The receiver 4 is arranged along the focal line of the linearly focusing mirror element 3, and is held there by means of support arms 5.

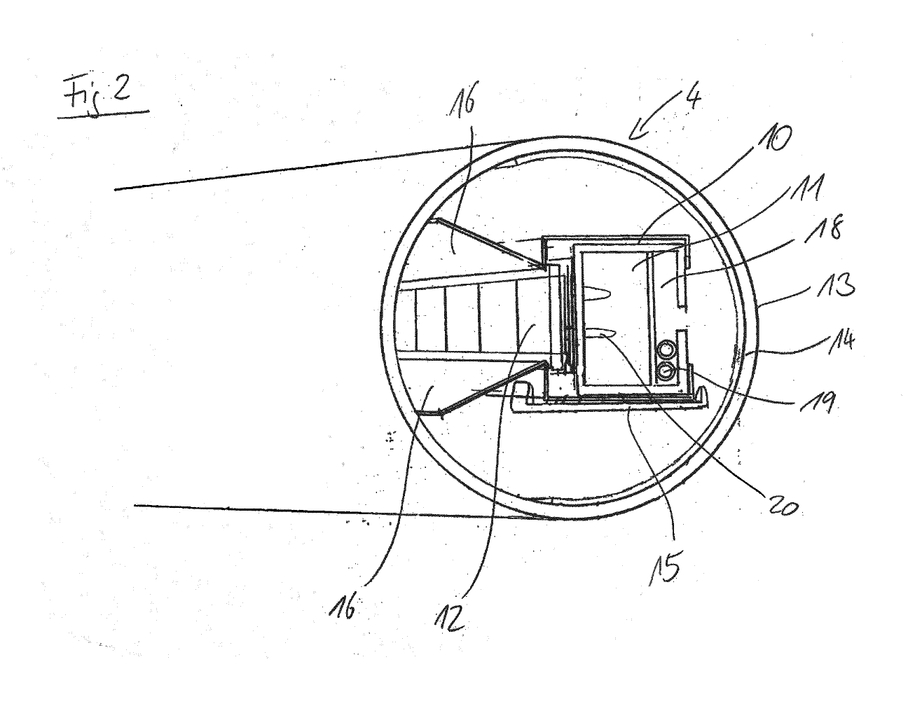

The linearly focusing mirror element 3 is a semi-paraboloid mirror trough. The receiver 4 is a receiver according to the invention, which may be designed, for example, as in FIG. 2, 3 or 4. The design of the receiver 4 is to be explained later on the basis of these figures.

The collector unit 2, comprising the linearly focusing mirror element 3 and the receiver 4, is mounted so as to be pivotable about a pivot axis 6, the pivot axis 6 extending along an edge of the linearly focusing mirror element 3. By means of a drive element 7, the collector unit 2 can be tilted about the pivot axis 6. The collector unit 2 can thus be made to track the position of the sun in respect of elevation.

The collector unit 2 is additionally arranged on a slewing mechanism 8. By means of this slewing mechanism 8, the collector unit 2 can be rotated about an axis 9 perpendicular to the pivot axis 5 of the collector unit 2. As a result of the tilting of the collector unit 2, on the one hand, and the rotation of the same about the rotation axis of the slewing mechanism 8, on the other hand, a two-axis tracking is achieved, namely, in respect of the elevation and the azimuth.

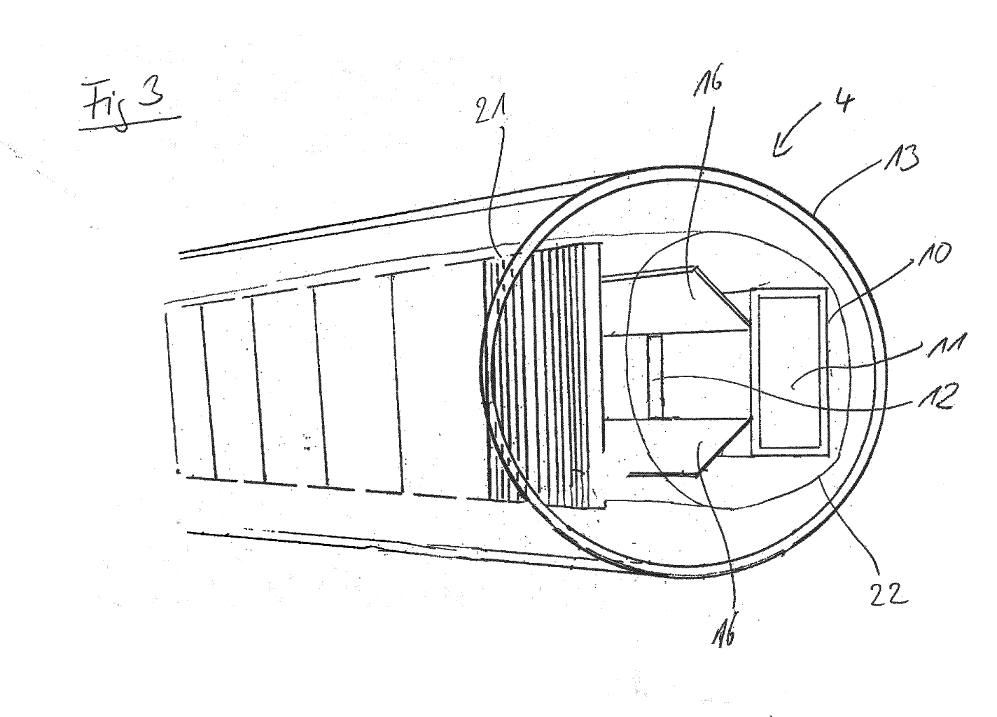

FIG. 2 shows a first exemplary embodiment of a receiver 4, as may be used in a solar plant 1 from FIG. 1. The receiver 4 comprises an elongate hollow profile 10, which has a duct 11 for a heat transfer fluid, for example a calcium chloride solution. Solar cells 12 are arranged on one side of the hollow profile 10. By means of these solar cells 12, solar radiation can be converted into electrical energy. In the case of the receiver 4 from FIG. 2 being used in a solar plant 1 according to FIG. 1, the solar cells 12 are arranged facing toward the linearly focusing mirror element 3 and along the focal line thereof. A beam-manipulating element (not represented in FIG. 2, cf. FIG. 3) is arranged in the beam path between the mirror element 3 and the solar cells 12. Moreover, the solar cells 12 are connected in series.

The solar cells 12 are connected to the hollow profile 10 in a thermally conductive manner. The heat that, in addition to the electrical energy, results at the solar cells 12 can then be supplied, via the hollow profile 10, to the heat transfer fluid in the duct 11. The heat stored in the heat transfer fluid can then be used outside of the receiver 4, for example in a Stirling engine or ORC system.

The arrangement composed of a hollow profile 10 and solar cells 12 is arranged in a transparent casing tube 13. In the exemplary embodiment represented, the casing tube 13 is made of glass, and is vacuumed. Thus, good thermal insulation of the hollow profile 10 is achieved in respect of the environment. Moreover, the outside of the hollow profile 10 is easy to clean.

On the side of the hollow profile 10 that faces away from the solar cells 12, there is a reflector 14 arranged on the inside of the casing tube 13. The reflector 14 consists of a multilayer metal foil. By means of this reflector 14, the thermal radiation radiated by the casing tube 13 is reflected back on to the latter. The heat losses can thus be further reduced.

In order to ensure a good transfer of heat between the solar cells 12 and the hollow profile 10, the solar cells 12 are joined together to form modular panels, wherein at least one solar cell 12 of such a modular plate is pressed on to the hollow profile 10 by means of a clamping element 15 made of spring steel. Owing to the mechanical connection between the individual solar cells 12 of the module plates, the adjacent solar cells 12 are pressed on to the hollow profile 10. In addition, thermal compound is provided between the solar cells 12 and the hollow profile 10, thereby further improving the transfer of heat.

Additionally provided are mirror plates 16, which act as a light trap for the solar cells 12. Solar radiation that is concentrated on to the receiver 4 and that is incident upon these mirror plates 16 is deflected on to the solar cells 12, and can be converted there into electrical energy. The mirror plates 16 thus make it possible to compensate inaccuracies in the positioning of the receiver, the tracking, etc., in that solar radiation that is not concentrated directly on to the solar cells 12 is deflected on to the latter by the mirror plates.

The mirror plates 16 may also be integral with a clamping element 15.

A cable routing 18 is provided on the side of the hollow profile 10 that faces away from the solar cells 12. Electrical cables 19, for connecting the solar cells 12, are arranged in this cable routing 18. Bypass diodes for the solar cells 12 may also be arranged in the cable routing 18.

Fins 20 are provided on the inside of the hollow profile 10, at the locations at which the solar cells 12 put heat into the hollow profile 10. The fins 20 are streamlined in form, and have heat transfer fluid flowing around them, whereby the transfer of heat from the hollow profile 10 to the heat transfer fluid can be further improved.

A second exemplary embodiment of a receiver 4 according to the invention is represented in FIG. 3. The receiver 4 from FIG. 3 can likewise be used in a solar plant 1 according to FIG. 1. In the exemplary embodiment from FIG. 3, elements that are comparable with those of the exemplary embodiment from FIG. 2 are denoted by the same reference numerals. For explanation of these elements, reference is also made to the statements relating to FIG. 2.

The receiver 4 from FIG. 3 comprises an elongate hollow profile 10, which is arranged in a casing tube 13 and has a duct 11 for a heat transfer fluid. Solar cells 12 are arranged on one side of the hollow profile 10, and therefore likewise in the casing tube 13. By means of these solar cells 12, solar radiation can be converted into electrical energy. By means of heat transfer fluid that flows through the hollow profile 10, the heat that occurs in this case can be removed and utilized.

The solar cells 12 are concentrator photovoltaic cells, which are not arranged continuously along the hollow profile 10, but at discrete points on the same. In order for solar radiation that is concentrated linearly on to the receiver 4, for example by a solar plant 1 according to FIG. 1, to be concentrated on to the solar cells 12, concentrator elements 21 are provided as beam-manipulating elements. The concentrator elements 21 are linear Fresnel lenses, by which the incident solar radiation that is concentrated linearly on to the receiver 4 is further focused, portionally, on to one solar cell 12 in each case.

Mirror plates 16, which act as a light trap for the solar cells 12, are provided on the hollow profile 10. Solar radiation that is not directly concentrated on to the solar cells 12 can be deflected on to the solar cells 12. The solar cells 12 each have a bypass diode (not represented).

The hollow profile 10 is arranged, together with the solar cells and the mirror plates 16, in a hose-shaped transparent film 22, which, in turn, is arranged entirely in the casing tube 13. At its ends, the hose-shaped transparent film 22 bears against the hollow profile 10 in a sealing manner, such that the region between the hollow profile 10 and the film 22 is tightly closed. In the said region, between the hollow profile 10 and the film 22, a greater pressure prevails during operation that in the region between the film 22 and the hollow profile 10, such that the hose-shaped transparent film 22 remains, as far as possible, arranged in a dimensionally stable manner between the hollow profile 10 and the casing tube 13. Owing to the film 22, heat losses resulting from convection can be reduced.

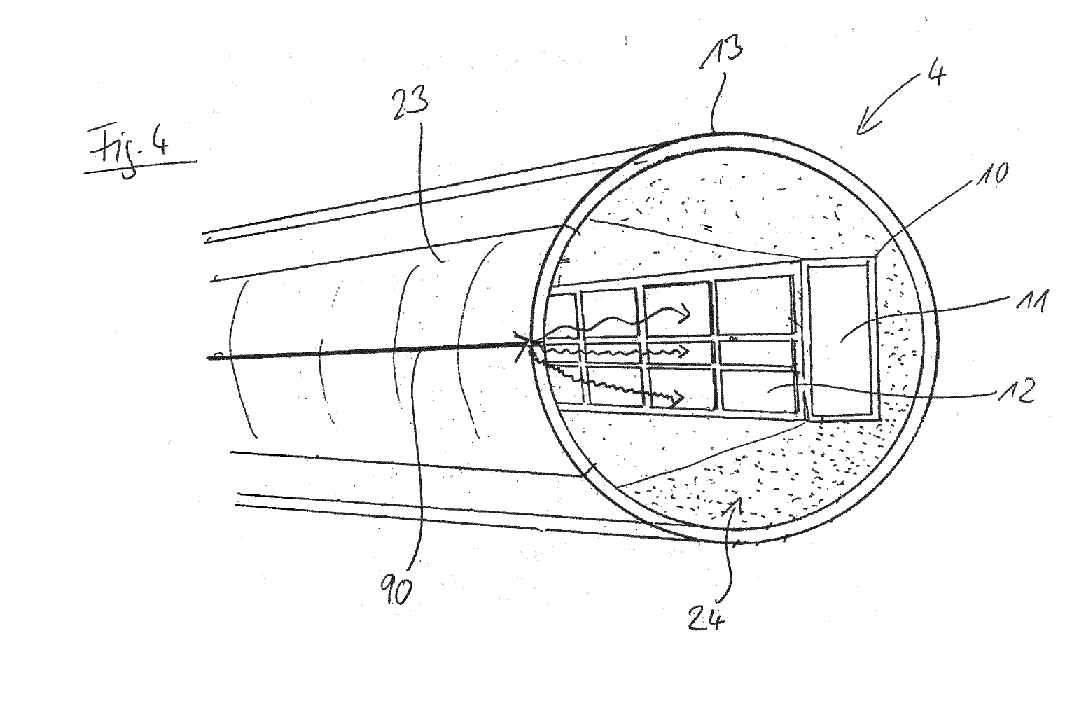

A further exemplary embodiment of a receiver 4 according to the invention is represented in FIG. 4. This receiver 4, likewise, can be used in a solar plant according to FIG. 1. In the exemplary embodiment from FIG. 4, elements that are comparable with those of the exemplary embodiments from FIGS. 2 and 3 are denoted by the same reference numerals. For explanation of these elements, reference is therefore also made to the statements above.

In the case of the receiver 4 from FIG. 4, a hollow profile 10, having solar cells 12 mounted thereon, is arranged inside a casing tube 13. The hollow profile 10 in this case has a duct 11 for a heat transfer fluid that serves to remove and utilize heat produced at the solar cells 12.

The solar cells 12 are each optimized for differing wavelengths of the solar radiation. In order for the individual solar cells 12 to be operated with the optimum possible radiation spectrum, the wall of the hollow profile 10 has an integrated beam splitter 23, by which the solar radiation, for example concentrated linearly in a solar plant 1 according to FIG. 1, that is incident upon the beam splitter, is split according to the wavelength and deflected on to the solar cells 12 optimized to the respective wavelengths. This is illustrated by the exemplarily represented beam path 90.

The region between the casing tube 13 and the hollow profile 10 is filled with aerogel 24. The aerogel 24 in this case is transparent in the region between the beam splitter 23 and the solar cells 12—i.e., in the region of the beam path of the linearly concentrated radiation—whereas inclusions of opacifiers are provided in the remaining region. The inclusions of opacifiers serve to reflect the thermal radiation that is radiated by the hollow profile 10 back on to the hollow profile 10. Heat losses can thus be reduced.

A further exemplary embodiment of a receiver 4 according to the invention is represented in FIG. 5. This receiver 4, likewise, can be used in a solar plant according to FIG. 1. In the exemplary embodiment from FIG. 5, elements that are comparable with those of the exemplary embodiments from FIG. 3 are denoted by the same reference numerals. To explain these elements, reference is therefore also made to the statements above.

In the case of the receiver 4 according to FIG. 5, the hollow profile 10 is semi-cylindrical in form. In the exemplary embodiment represented, it is exactly semi-cylindrical, i.e. the flat cover surface 10′ for receiving the solar cells 12 that is formed by the secant line of the semi-cylinder goes through the midpoint of the semi-cylinder. It is also possible for the cover surface to be displaced downward or upward, giving the hollow profile a horseshoe shape in cross section. Two strips 26, extending parallelwise, are provided on the cover surface 10′. Between them, they form a receiving pocket 27 for the solar cells 12. In addition, at the top of the hollow profile 10 there is a mounting 28 for the Fresnel lenses 21, which act as an optical concentrator element. The result is thus a particularly compact and stiff construction, with fixed positioning of the Fresnel lens 21, which, moreover, can be easily produced and mounted.

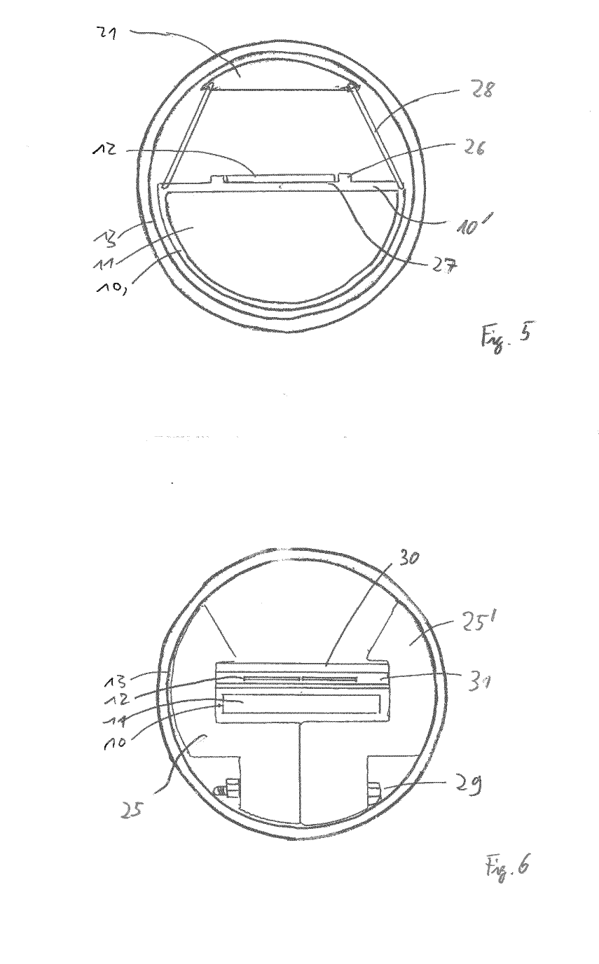

A further exemplary embodiment of a receiver 4 according to the invention is represented in FIG. 6. This receiver 4, likewise, can be used in a solar plant according to FIG. 1. In the exemplary embodiment from FIG. 6, elements that are comparable with those of the exemplary embodiments from FIGS. 2 to 5 are denoted by the same reference numerals. To explain these elements, reference is also made to the statements above.

In the case of this exemplary embodiment, the hollow profile 10 is held in the casing tube 13 by means of holding disks 25. When in the mounted state, the halves of the holding disks 25 are fitted on to the lateral sides of the hollow profile 10 and secured by means of a screwed connection 29. The outer contour of the holding disks 25 matches the inner wall of the casing tube 13, such that they fix the hollow profile 10 in an exact position in the casing tube. In the upper region, the holding disks 25 have a cut-out in the manner of a segment of a circle. This provides a free beam path for the incident light and heat, radiated through the casing tube 13, on to the solar cells 12 and the hollow profile 10.

By means of their upper region 25′ that adjoins the cut-out, the holding disks 25 grip the top side of the hollow profile 10 in a finger-like manner. The dimensions are selected such that a press fit against the hollow profile is produced, such that the upper regions of the holding disks thus act as a clamping element for the solar cells 12. Additionally provided is a glass disk, as a transparent pressure plate 30, which is supported by the solar cell 12 and spans the front side thereof. It is pressed by clamping elements, here in the form of the finger-type regions 25′ of the holding disks 25, on to the solar cell 12, and the latter is pressed on to the hollow profile 10, thereby providing for a good, reliable transfer of heat between the solar cell 12 and the hollow profile 10. In order to avoid stresses, a likewise transparent filling compound 31 is preferably provided between the pressure plate 30 and the solar cell 12. It is to be noted that the transparent pressure plate 30 is not limited to this exemplary embodiment, but may also be provided in the case of the other exemplary embodiments.

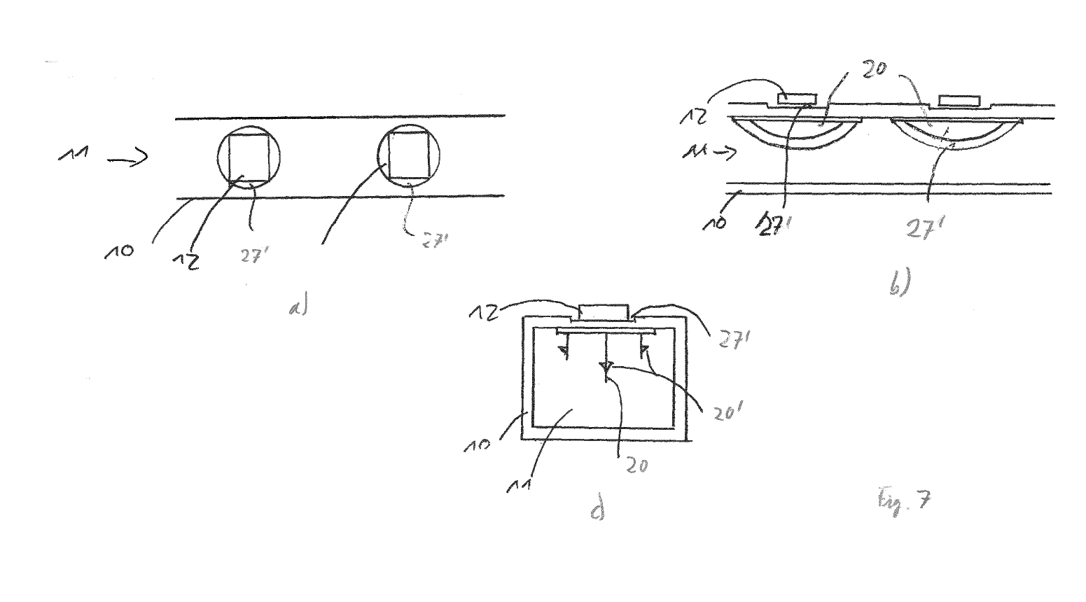

Further details and exemplary embodiments for the fins 20 are represented in FIGS. 7a-c. FIG. 7a, on the basis of the example of the second exemplary embodiment represented in FIG. 3, shows a top view of the hollow profile 10, while FIG. 7b shows a longitudinal section, and FIG. 7c shows a cross section through the hollow profile 10. The figures show the solar cells 12, which are arranged in circular recesses 27′. The fins 20 are realized as arc segments and, at positions beneath the respective solar cells 12, project downward, in the manner of a comb, into the interior of the hollow profile 10. The fins 20 are arranged in a discontinuous manner, as viewed in the direction of flow of the heat transfer fluid 11. Between them, there are regions without fins. In addition, in their end regions, the fins 20 have lateral projections 20′. The heat transfer fluid 11 flowing through this interior is swirled by the discontinuously arranged fins 20. An additional turbulence is also generated by the lateral projections 20′. This results in a thorough mixing of the heat transfer fluid 11, thereby providing for a significantly improved transfer and removal of heat, compared with the laminar flow that is conventionally achieved. The thus improved removal of heat both increases the efficiency and achieves better cooling of the solar cells 12. It is understood that the fins 20 may also be provided in the case of other embodiments.

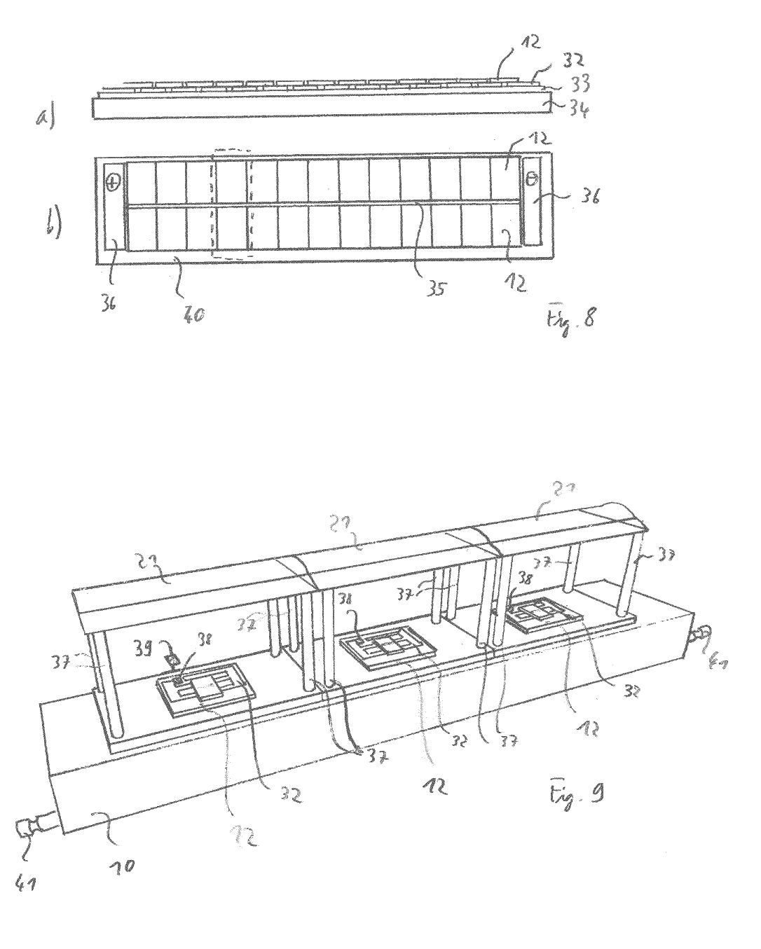

FIGS. 8 a, b show a lateral view and a top view of a panel having a plurality of solar cells 12. The solar cells 12 are arranged on a conductive structure 32 composed of copper material. The latter provides for electrical contacting of the solar cells 12 and for a good transfer of heat for the purpose of cooling. The conductive structure 32 is arranged, over a thin insulating layer 33, on a substrate 34, which is preferably composed of a metal having good thermal conductivity, such as copper or aluminum, or a heat-resistant ceramic material.

The solar cells 12 are arranged in a double row on the base plate 34, with a separating piece 35 between the rows. In each case, a solar cell 12 above the separating piece 35 and that immediately opposite it, beneath the separating piece 35, are combined to form a pair (see broken line in FIG. 8b). The solar cells (here, two), in each case constituting a pair, are electrically connected in parallel, while the pairs are connected in series over the length of the solar panel. A connecting terminal 36 is therefore provided at each end for the purpose of electrical connection. Owing to the parallel connection in pairs, a high degree of shading tolerance is achieved. Consequently, an effective, large solar panel can be formed from relatively small solar cells, which can be produced inexpensively and are easily processed or mounted. On at least one lateral side, the solar panel has at least one widened portion 40. The latter serves as a locating surface for the clamping element 16, or the fingers 25′ thereof, for better contact pressure on to the hollow profile 10.

The fixed arrangement of hollow profile, cells and beam-manipulating element (Fresnel lens 21) is represented in FIG. 9. The three Fresnel lenses 21 represented are supported on a plurality of columns 37, which are arranged with their foot on the hollow profile 10. Three concentrator solar cells are provided, which each have a pair of solar cells 12 connected in parallel. A bypass diode 38 is provided for each of these pairs of solar cells 12. It is designed, in the case of uneven irradiation of the two solar cells 12, to prevent reverse current loading of the solar cell 12 that receives the lesser radiation. For the purpose of reliably removing heat loss that occurs in this case, the bypass diode 38 is arranged on the same carrier substrate as the pair of solar cells 12. Preferably, for this purpose, the bypass diode is mounted without a housing. For protection against incident light radiation, a cover 39 may be provided, or the bypass diode may be arranged away from the focus, where only a small amount of irradiation (scattered light) need be taken into account. A compact and robust arrangement is thereby achieved.

1. A receiver for arrangement in the focal line of a solar collector with a linearly focusing mirror element, comprising an elongate hollow profile forming a duct for heat transfer fluid and solar cells arranged on one side of the elongate hollow profile for converting solar radiation into electrical energy, wherein the solar cells and the hollow profile are connected in a thermally conductive manner, wherein the hollow profile and the solar cells are arranged in a transparent casing tube in such a manner that at least one beam-manipulating element is arranged between the casing tube and the solar cells, wherein the hollow profile, solar cells casing tube, and at least one beam-manipulating element are a fixed relative to each other.

2. The receiver of claim 1, wherein the at least one beam-manipulating element comprises concentrator elements for concentrating solar radiation that is incident upon the receiver in a linearly focused manner into individual focal points along the focal line.

3. The receiver of claim 1, wherein the at least one beam-manipulating element comprises a beam splitter for splitting incident solar radiation into differing wavelengths and deflecting split solar radiation on to the solar cells, and wherein the solar cells are optimized with respect to the differing wavelengths.

4. The receiver of claim 1, wherein a region between the hollow profile and the transparent casing tube is vacuumed or filled with inert gas.

5. The receiver of claim 1, comprising connections for flushing with gas at both ends of the casing tube.

6. The receiver of claim 1, comprising a reflector disposed between a side of the hollow profile that faces away from the solar cells and the casing tube to reflect at least one of thermal radiation from the hollow profile and leakage radiation from the beam-manipulating element on to the casing tube.

7. The receiver of claim 1, wherein the at least one beam-manipulating element is integral with the casing tube.

8. The receiver of claim 1, wherein a thermal longitudinal extent of the hollow profile is approximately equal to a thermal longitudinal extent of the casing tube.

9. The receiver of claim 1, wherein the hollow profile is semi-cylindrical or horseshoe-shaped.

10. The receiver of claim 1, comprising at least one holding disk for positioning the hollow profile in the casing tube, wherein an outer contour of the at least one holding disk is matched to an inner wall of the casing tube.

11. The receiver of claim 1, wherein the hollow profile comprises recesses or protuberances for receiving the solar cells in a form-fitting manner.

12. The receiver of claim 1, comprising at least one tensioning element for gripping around the hollow profile and at least one solar cell in such a manner that the at least one solar cell is pressed on to the hollow profile.

13. The receiver of claim 12, wherein the tensioning element comprises a plurality of fingers, for pressing the at least one solar cell against the hollow profile.

14. The receiver of claim 12, comprising a transparent rigid pressure plate, arranged between the tensioning element and the at least one solar cell, that spans a front face of the solar cell.

15. The receiver of claim 12, comprising a widened portion outside of at least one lateral edge of a substrate that carries the at least one solar cell, wherein the widened portion is configured to form a non-shading locating surface for the at least one tensioning element.

16. The receiver of claim 1, comprising fins in the duct for heat transfer fluid of the hollow profile, in regions in which the solar cells are arranged on the hollow profile.

17. The receiver of claim 16, wherein the fins are arranged in a discontinuous manner along the direction of flow of the heat transfer fluid.

18. The receiver of claim 1, wherein the solar cells comprise one or both of concentrator photovoltaic cells and thermovoltaic cells.

19. The receiver of claim 1, wherein the solar cells are arranged transversely in relation to the longitudinal extent of the receiver and are connected in parallel in pairs, and wherein the pairs are connected in series.

20. The receiver of claim 19, comprising a bypass diode for each pair of solar cells.

21. The receiver of claim 20, wherein the bypass diode is arranged on a common substrate with the pair of solar cells.

22. A solar plant comprising the receiver of claim 1 arranged in the focal line of a linearly focusing mirror element, wherein the receiver is arranged in such a manner that the solar cells of the receiver face toward the linearly focusing mirror element.

23. The solar plant of claim 22, wherein the solar plant comprises a Stirling engine, an Organic Rankine Cycle (ORC) system or a thermal refrigerating machine that is operated with heat transfer fluid heated in the receiver.

24. The solar plant of claim 22, wherein the solar plant can track on one axis or on two axes.

25. The receiver of claim 4, wherein at least one of the hollow profile and the casing tube is made of glass.

26. The receiver of claim 1, wherein the hollow profile comprises graphite.

27. The receiver of claim 10, wherein the at least one holding disk comprises a cut-out on a side that faces toward the mirror element.

28. The receiver of claim 12, wherein the at least one tensioning element is in the form of a clamping element.

29. The receiver of claim 17, wherein the fins comprise barbs or a comb.

30. The receiver of claim 21, wherein the bypass diode is realized without a housing.

31. The receiver of claim 21, wherein the bypass diode is protected by a reflector that is mounted between the bypass diode and the casing tube, and that is not connected to the bypass diode.
